(19) United States
(12) Patent Application Publication
(10) Pub. No.: US 2018/0226657 A1
(43) Pub. Date: Aug. 9, 2018

(54) PRODUCT CUTTING METHOD

(71) Applicant: HONDA MOTOR CO., LTD., Tokyo (JP)

(72) Inventor: Daigo Mukasa, Tochigi-ken (JP)

(21) Appl. No.: 15/885,957

(22) Filed: Feb. 1, 2018

(30) Foreign Application Priority Data
Feb. 8, 2017 (JP) 2017-020838

(51) Int. Cl. H01M 4/88; B65H 35/00; H01M 4/92

(52) U.S. Cl. CPC H01M 4/8878; B65H 35/008; B65H 2701/172; H01M 4/921; B65H 2301/51537; H01M 4/8807

(57) ABSTRACT

A product cutting method performs a cutting step of forming a product cutting line in a sheet material, and forming tongue piece portions, which are adjacent to an outer periphery of a product together with being connected to the sheet material, and are capable of being displaced with respect to the sheet material in a thickness direction of the sheet material by forming auxiliary cutting lines continuous with the product cutting line in end members of the sheet material, and an extracting step of taking out the product from the end members by applying a vacuum suction to an extracting device.

### CROSS-REFERENCE TO RELATED APPLICATION

This application is based upon and claims the benefit of priority from Japanese Patent Application No. 2017-020838 filed on Feb. 8, 2017, the contents of which are incorporated herein by reference.

### BACKGROUND OF THE INVENTION

### Field of the Invention

The present invention relates to a product cutting method for cutting a porous sheet-shaped product from a sheet material.

### Description of the Related Art

Porous carbon paper has conventionally been used as a gas diffusion layer for a fuel cell (for example, see Japanese Patent No. 5308989).

### SUMMARY OF THE INVENTION

Incidentally, a gas diffusion layer for a fuel cell is manufactured by cutting a sheet material made of carbon paper by a trimming process or the like. A product such as a gas diffusion layer or the like which is formed by cutting the sheet material is taken out or extracted from the sheet material by generating vacuum suction in a suction pad of an extracting device, for example, and then the product is conveyed to a subsequent process.

However, when the product is taken out from the sheet material using a suction pad, the cut surfaces of the product become caught on the remaining part of the sheet material, and cases occur in which the product falls down from the suction pad. In particular, if the product possesses porosity such as a gas diffusion layer, it is not easy to increase the suction force of the suction pad that is applied with respect to the product, and therefore, a problem results in that the product tends to easily fall down from the suction pad during the extraction process.

The present invention has been devised taking into consideration the aforementioned problem, and has the object of providing a product cutting method which is capable of easily and reliably taking out or extracting a product from a sheet material.

In order to achieve the above-described object, a product cutting method according to the present invention is a product cutting method for cutting a porous sheet-shaped product from a sheet material, comprising a cutting step of forming a product cutting line in the sheet material having a shape of the product, and together therewith, forming a tongue piece portion, which lies adjacent to an outer periphery of the product together with being connected to the sheet material, and is capable of being displaced in a thickness direction of the sheet material by forming auxiliary cutting lines continuous with the product cutting line outside of the shape of the product of the sheet material, and after the cutting step, performing an extracting step of taking out the product from an end member by applying a vacuum suction to an extracting device.

According to such a method, when the product is taken out from the sheet material, even if a cut surface of the product becomes caught on the tongue piece portion which is formed in the remaining portion of the sheet material, the tongue piece portion is displaced with respect to the remaining portion of the sheet material, and is capable of following the movement of the product. Stated otherwise, even if catching takes place between the product and the tongue piece portion, the tongue piece portion becomes deformed following the movement of the product, and therefore, the product can be taken out while preventing the product from falling down from the extracting device due to such catching. Further, in the case that the cut surface of the product becomes caught, respectively, on the tongue piece portion and another remaining portion of the sheet material, by first releasing the caught condition between the product and the remaining portion, and thereafter releasing the caught condition between the product and the tongue piece portion, it is possible to prevent the product from falling down from the extracting device, and to take out the product from the sheet material. In other words, it is possible to easily and reliably take out or extract the product from the sheet material.

In the product cutting method according to claim 1, the product may have a rectangular shape, and the auxiliary cutting lines may include first cutting lines formed to extend from a portion of the product cutting line constituting one side of the product in a direction in which the one side extends, and second cutting lines formed to extend from the first cutting lines in a direction of a side that intersects the one side of the product.

In accordance with such a method, when the rectangular shaped product is taken out from the sheet material, if the vicinity of a corner part (vertex) of the rectangular shape becomes caught, the moment increases, and it becomes easy for the product to fall down from the extracting device. However, according to the method of the present invention, a distal end of the tongue piece portion is located at the corner portion, and thus even if catching takes place, the distal end is displaced following the movement of the corner portion, and therefore, falling down of the product can be suppressed even more.

In the above-described product cutting method, the product cutting line may have short side cutting lines and a long side cutting lines, the first cutting lines may be formed so as to extend from the short side cutting lines in a direction in which the short side cutting lines extend, and the second cutting lines may be formed so as to extend from the first cutting lines toward sides where the long side cutting lines are positioned.

In accordance with such a method, since the tongue piece portion is capable of following the long side portion of the product, it is possible to effectively prevent the product from falling down from the extracting device.

In the above-described product cutting method, the auxiliary cutting lines may be formed so as to be positioned respectively at corner portions of the product.

According to such a method, it is possible to more effectively prevent the product from falling down from the extracting device.

In the above-described product cutting method, the length of the second cutting lines may be less than or equal to half the length of the long side cutting lines.

In accordance with such a method, since adjacently disposed second cutting lines are not connected to each other, with a simple shape, it is possible to reliably connect the tongue piece portion to the sheet material.

In the above-described product cutting method, the product may be an electrode of a fuel cell.

According to such a method, electrodes for a fuel cell can be manufactured efficiently.

According to the present invention, when the product is taken out from the sheet material, even if the product becomes caught on a remaining portion of the sheet material, the tongue piece portion is displaced with respect to the remaining portion of the sheet material, and is capable of following the movement of the product. Therefore, falling down of the product as a result of becoming caught is prevented, and the product can easily and reliably be taken out or extracted from the sheet material.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a flowchart of a product cutting method according to an embodiment of the present invention;

FIG. 2A is a cross-sectional view of a sheet material for describing a cutting step of the product cutting method according to an embodiment of the present invention;

FIG. 2B is a plan view of a sheet material for describing the cutting step;

FIG. 3 is a schematic plan view of the sheet material for describing an extracting step;

FIG. 4A is a cross-sectional explanatory view taken along line IVA-IVA of FIG. 3;

FIG. 4B is a cross-sectional explanatory view taken along line IVB-IVB of FIG. 4A;

FIG. 5A is a cross-sectional explanatory view showing a state in which the product shown in FIG. 4A is lifted upward;

FIG. 5B is a cross-sectional explanatory view taken along line VB-VB of FIG. 5A; and

FIG. 6 is a cross-sectional explanatory view showing a state in which the product shown in 5B is further lifted upward.

### DESCRIPTION OF THE PREFERRED EMBODIMENTS

A preferred embodiment of a product cutting method according to the present invention will be described in detail below with reference to the accompanying drawings.

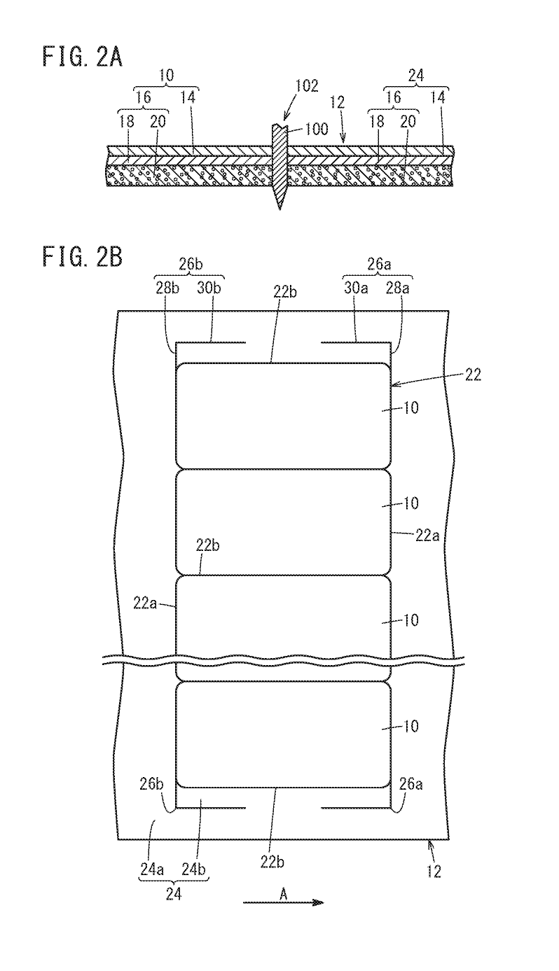

The product cutting method according to the present embodiment is a method by which a sheet-shaped product 10 is cut out from a porous sheet material 12. As shown in FIG. 2A, the product 10 is configured, for example, as an electrode of a non-illustrated fuel cell, and is a sheet-shaped member (film-like member) having a given porosity. The product 10 is configured in a rectangular shape (see FIG. 2B). The product 10 comprises an electrode catalyst layer 14, and a gas diffusion layer 16 that is laminated on the electrode catalyst layer 14.

The electrode catalyst layer 14 is bonded to a surface of a solid polymer electrolyte membrane of the fuel cell, and porous carbon particles supporting a platinum alloy on the surface thereof are evenly coated onto the surface of the gas diffusion layer 16. The gas diffusion layer 16 is formed from a microporous layer 18 possessing both porosity and conductivity, and a carbon layer 20 such as carbon paper or a carbon cloth. In the case that the product 10 is an electrode for a fuel cell as was described above, the sheet material 12 is a laminated body made up from the electrode catalyst layer 14 and the gas diffusion layer 16, and for example, is used by being wound in the form of a non-illustrated roll.

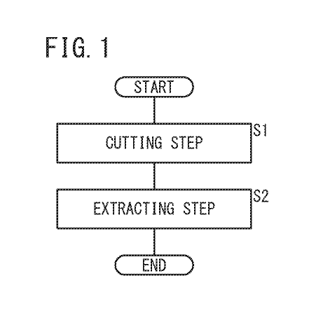

In the product cutting method, as shown in FIGS. 1 to 6, the following steps are performed. Namely, a cutting step (step S1) of conveying the sheet material 12 which is wound in a roll by a roll-to-roll method, forming a product cutting line 22 in the sheet material 12 having a shape of the product 10, and together therewith, forming auxiliary cutting lines 26a, 26b continuous with the product cutting line 22 in end members 24 of the sheet material 12, and an extracting step (step S2) of taking out the product 10 from the end members 24 which make up the remaining part of the sheet material 12.

In the cutting step, for example, a cutting device 102 having a cutting blade 100 for trimming is used (see FIG. 2A). As shown in FIG. 2B, in the cutting step, the product cutting line 22 is formed in the sheet material 12 in a manner so that a plurality of products 10 are arranged in a widthwise direction of the sheet material 12 (a direction perpendicular to the arrow A, which is the conveying direction of the sheet material 12). More specifically, the product cutting line 22 has a plurality of short side cutting lines 22a forming short sides of the products 10, and long side cutting lines 22b forming long sides of the products 10. The long sides of the products 10 lying adjacent to each other are formed by a common long side cutting line 22b. Further, corner portions of the products 10 are chamfered in rounded shapes.

In the cutting step, by forming a plurality of auxiliary cutting lines 26a, 26b in the end members 24 of the sheet material 12, tongue piece portions 24b are formed as parts of the end members 24. The tongue piece portions 24b are connected to end member portions 24a, which are portions apart from the tongue piece portions 24b of the end members 24. The tongue piece portions 24b lie adjacent to a part of the outer periphery of the product 10, and are capable of being displaced with respect to the end member portions 24a in a thickness direction of the end member portions 24a. More specifically, the tongue piece portions 24b are formed so as to be capable of swinging about connecting portions with the end member portions 24a acting as a fulcrum, by applying a force in the thickness direction thereof.

The respective auxiliary cutting lines 26a, 26b are continuous with the short side cutting lines 22a (at the respective corner portions of the product cutting line 22) located at outermost positions in the widthwise direction of the sheet material 12. The auxiliary cutting lines 26a that are located on one end side (in the sheet conveying direction, the direction of the arrow A) of the product 10 each include a first cutting line 28a extending from the product cutting line 22 in the direction of extension of the short side, and a second cutting line 30a formed from the first cutting lines 28a along the direction of the long side of the product 10. The second cutting line 30a extends from an extended end of the first cutting line 28a toward the other end side (in a direction opposite to the direction of the arrow A) of the product 10.

The auxiliary cutting lines 26b that are located on the other end side of the product 10 are symmetrical with respect to the auxiliary cutting lines 26a, and each include a first cutting line 28b and a second cutting line 30b. The second cutting line 30b extends from an extended end of the first cutting line 28b toward the one end side (in the direction of the arrow A) of the product 10. The lengths of the second cutting lines 30a, 30b are set to be less than or equal to half the length of the long side cutting lines 22b.

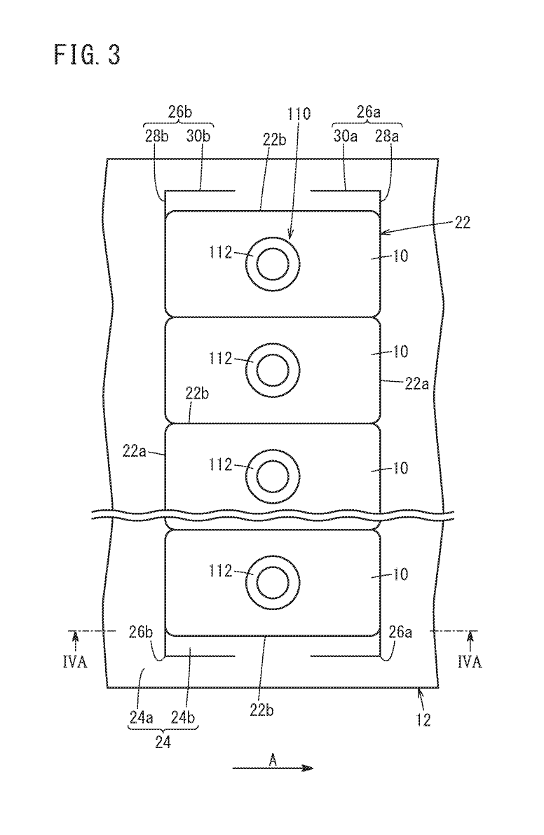

In the extracting step, as shown in FIGS. 3 to 6, after the cutting step has been performed, a plurality of suction pads 112 of the extracting device 110 are pulled upward respectively in a state with vacuum suction of the suction pads 112 being applied to surfaces of the respective products 10, thereby taking out or extracting the products 10 from the end members 24. In FIGS. 3 to 6, only the carbon layer 20 of the sheet material 12 (product 10) is shown, and illustration of the electrode catalyst layer 14 and the microporous layer 18 is omitted.

At this time, cut surfaces 10as of the short sides of the product 10 may become caught on cut surfaces 24as of the end member portions 24a, and cut surfaces 10bs of the long sides of the product 10 may become caught on cut surfaces 24bs of the tongue piece portions 24b.

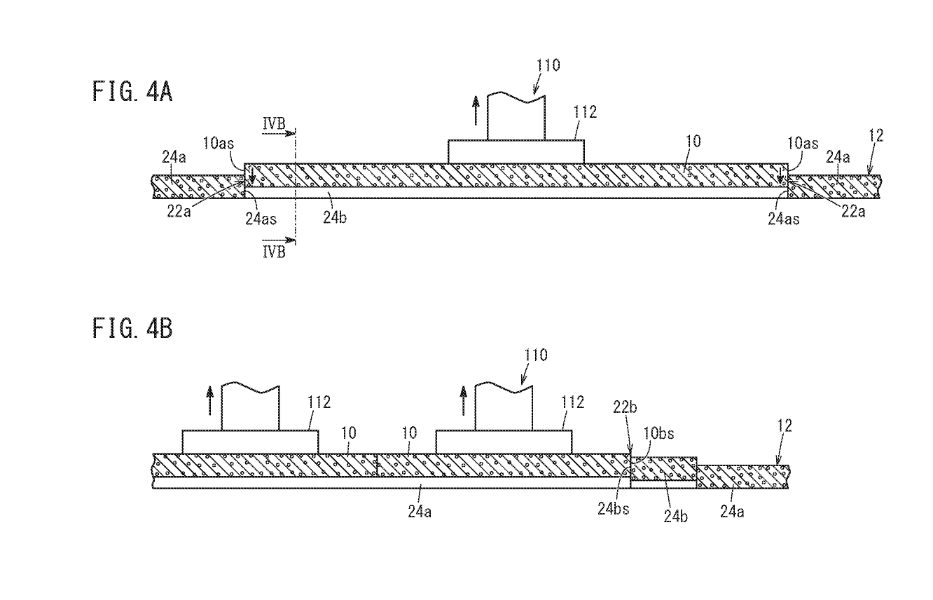

As shown in FIGS. 4A and 4B, at an initial stage when the product 10 is pulled upward by the suction pads 112, a downward tensile force acts on the cut surfaces 10as on the short sides of the product 10 by the cut surfaces 24as of the end member portions 24a. On the other hand, since the tongue piece portions 24b are displaced upwardly with respect to the end member portions 24a, the tensile force applied with respect to the cut surfaces 10bs of the long sides of the product 10 by the cut surfaces 24bs of the tongue piece portions 24b is suppressed.

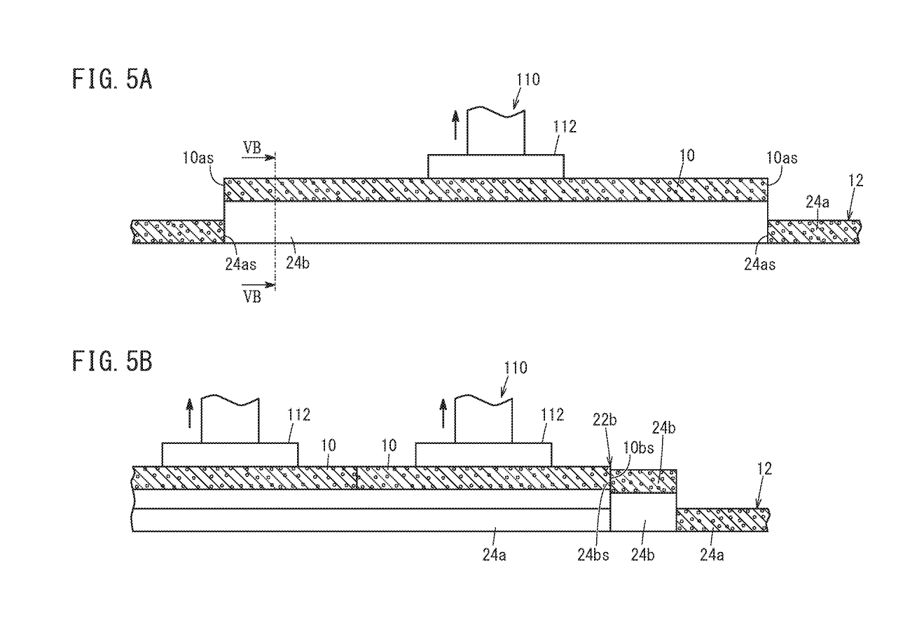

In addition, as shown in FIGS. 5A and 5B, when the product 10 is pulled upward further by the suction pads 112, the caught condition of the cut surfaces 10as of the short sides of the product 10 with respect to the cut surfaces 24as of the end member portions 24a is released. On the other hand, since the tongue piece portions 24b are further displaced upwardly with respect to the end member portions 24a, the tensile force applied with respect to the cut surfaces 10bs of the long sides of the product 10 by the cut surfaces 24bs of the tongue piece portions 24b is suppressed.

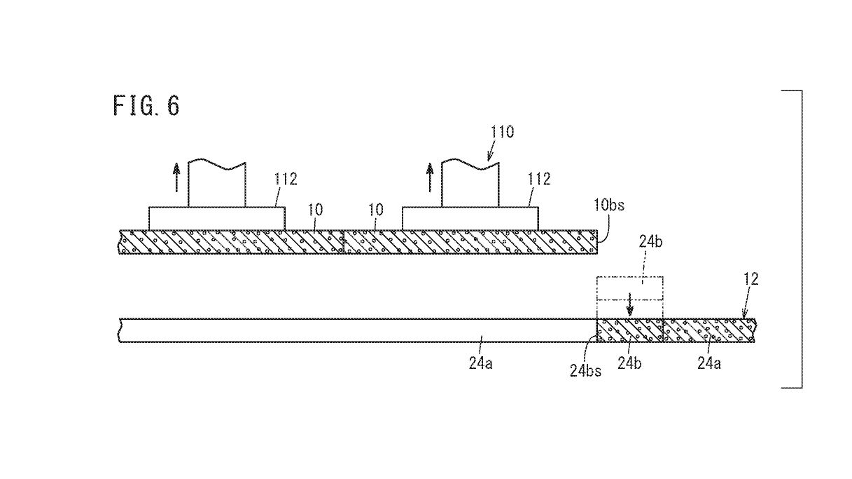

Thereafter, when the product 10 is pulled upward by the suction pads 112, a downwardly directed tensile force is applied to the cut surfaces 10bs of the long sides of the product 10 by the cut surfaces 24bs of the tongue piece portions 24b. In addition, as shown in FIG. 6, the product 10 is taken out from the end members 24 by the cut surfaces 10bs of the long sides of the product 10 becoming disengaged from the cut surfaces 24bs of the tongue piece portions 24b. The tongue piece portions 24b remain on the side of the end member portions 24a.

As described above, when the product 10 is taken out from the sheet material 12, assuming that the tongue piece portions 24b are formed, even if the cut surfaces 10bs of the product 10 become caught on the cut surfaces 24bs of the tongue piece portions 24b, the tongue piece portions 24b are displaced with respect to the end member portions 24a in following relation with the product 10, and therefore, it is possible to prevent falling down of the product 10 as a result of becoming caught. Further, even if both of the end member portions 24a and the tongue piece portions 24b become caught, since the tongue piece portions 24b are displaced, the tensile force is mitigated, and thus it is possible to prevent the product 10 from falling down. Consequently, it is possible to easily and reliably take out or extract the product 10 from the end members 24.

The auxiliary cutting lines 26a include the first cutting lines 28a, which are formed to extend from the short side cutting lines 22a of the product cutting line 22 in the direction in which the short side cutting lines 22a extend, and the second cutting lines 30a, which are formed to extend from the first cutting lines 28a in the direction of the long sides that intersect with the short sides of the product 10 (toward sides where the long side cutting lines 22b are positioned). The auxiliary cutting lines 26b include the first cutting lines 28b, which are formed to extend from the short side cutting lines 22a of the product cutting line 22 in the direction in which the short side cutting lines 22a extend, and the second cutting lines 30b, which are formed to extend from the first cutting lines 28b in the direction of the long sides that intersect with the short sides of the product 10 (toward sides where the long side cutting lines 22b are positioned).

In accordance with this feature, the tongue piece portions 24b are formed so that distal end portions thereof lie adjacent to the corner portions of the rectangular shaped product 10. Therefore, when a force is applied thereto, the tensile force applied to the corner portions where the product 10 is susceptible to falling down is mitigated, and therefore, falling down of the product 10 can be suppressed even more. Further, since the tongue piece portions 24b are capable of following the long side portions of the product 10, it is possible to effectively prevent the product 10 from falling down from the extracting device 110.

Furthermore, the auxiliary cutting lines 26a, 26b are formed so as to be positioned respectively at the corner portions of the product 10. In accordance with this feature, it is possible to more effectively prevent the product 10 from falling down from the extracting device 110.

Further, the lengths of the second cutting lines 30a, 30b are less than or equal to half the length of the long side cutting lines 22b. In accordance with this feature, since the adjacently disposed second cutting lines 30a, 30b are not connected to each other, with a simple shape, it is possible to reliably connect the tongue piece portions 24b to the sheet material 12.

According to the present embodiment, electrodes for a fuel cell which constitute the product 10 can be manufactured efficiently.

The present embodiment is not limited to the method described above. The product 10 which is cut out by the product cutting method is not limited to being an electrode for a fuel cell, and may be any type of product as long as it is a sheet-shaped product that possesses porosity. Further, in the above-described product cutting method, an example has been shown in which a plurality of products 10 are cut out at once from the sheet material 12, however, it is also possible to cut out one product 10 at a time from the sheet material 12. Further, in the cutting step, the product cutting line 22 and the auxiliary cutting lines 26a, 26b may be formed by laser machining.

What is claimed is:

1. A product cutting method for cutting a porous sheet-shaped product from a sheet material, comprising:
a cutting step of forming a product cutting line in the sheet material having a shape of the product, and together therewith, forming a tongue piece portion, which is adjacent to an outer periphery of the product together with being connected to the sheet material, and is capable of being displaced in a thickness direction of the sheet material by forming auxiliary cutting lines continuous with the product cutting line outside of the shape of the product of the sheet material; and
after the cutting step, performing an extracting step of taking out the product from an end member by applying a vacuum suction to an extracting device.

2. The product cutting method according to claim 1, wherein:
the product has a rectangular shape; and
the auxiliary cutting lines include:
first cutting lines formed to extend from a portion constituting one side of the product of the product cutting line in a direction in which the one side extends; and
second cutting lines formed to extend from the first cutting lines in a direction of a side that intersects the one side of the product.

3. The product cutting method according to claim 2, wherein:
the product cutting line has short side cutting lines and long side cutting lines;
the first cutting lines are formed so as to extend from the short side cutting lines in a direction in which the short side cutting lines extend; and
the second cutting lines are formed so as to extend from the first cutting lines toward sides where the long side cutting lines are positioned.

4. The product cutting method according to claim 3, wherein the auxiliary cutting lines are formed so as to be positioned respectively at corner portions of the product.

5. The product cutting method according to claim 4, wherein a length of the second cutting lines is less than or equal to half the length of the long side cutting lines.

6. The product cutting method according to claim 1, wherein the product is an electrode of a fuel cell.
